(19) United States
(12) Patent Application Publication
(10) Pub. No.: US 2020/0220625 A1
(43) Pub. Date: Jul. 9, 2020

(54) ELECTRODE DEVICE

(71) Applicant: SONY SEMICONDUCTOR SOLUTIONS CORPORATION, KANAGAWA (JP)

(72) Inventors: MASAYUKI TANAKA, KANAGAWA (JP); MASAHIRO UNO, TOKYO (JP)

(21) Appl. No.: 16/628,118

(22) PCT Filed: Apr. 10, 2018
(86) PCT No.: PCT/JP2018/015076

§ 371 Date: Jan. 2, 2020

(30) Foreign Application Priority Data
Jul. 11, 2017 (JP) 2017-135397

(51) Int. Cl. H04B 13/00; H04B 17/318; H04W 76/10

(52) U.S. Cl. CPC H04B 13/005; H04W 76/10; H04B 17/318

(57) ABSTRACT

To suppress the occurrence of communication not intended by a user. An electrode device including a first electrode and a second electrode, in which the second electrode has a region facing one surface of the first electrode, and a region protruding to the side of the other surface of the first electrode.

### TECHNICAL FIELD

The present disclosure relates to an electrode device.

### BACKGROUND ART

In recent years, research on a human body communication system also called body area network (BAN) has been advanced. The human body communication system includes a plurality of terminals brought close to the user's human body. Each terminal has at least two sheets of electrodes, and when a terminal that the user wears generates a potential difference between the two sheets of electrodes, an electric field distribution is generated on the surface of the user's human body. Due to contact between the user having an electric field distribution and another terminal, or spatial coupling between terminals, a potential difference occurs between the two sheets of electrodes of the other terminal, the other terminal extracts a signal from the potential difference, and thus human body communication (electric field communication) can be realized.

Patent Document 1 discloses a gate system using human body communication. In the gate system, an electrode installed on a gate communicates with a portable terminal carried by the user through spatial coupling, and the user authentication is performed on the basis of the communication.

### CITATION LIST

### Patent Document

Patent Document 1: Japanese Patent Application Laid-Open No. 2012-244517

### SUMMARY OF THE INVENTION

### Problems to be Solved by the Invention

However, in the human body communication system, there may be a case where communication not intended by the user is performed. For example, there is a concern that in a system where a door is locked and unlocked by spatial coupling between an electrode installed on a door of a house and a user outside the house, in a case where the user inside the house approaches the door, the user and the electrode are spatially coupled to each other and unlocking of the door not intended by the user is performed.

Therefore, the present disclosure proposes a new and improved electrode device that can suppress the occurrence of communication not intended by the user.

### Solution to Problems

According to the present disclosure, there is provided an electrode device including a first electrode and a second electrode, in which the second electrode has a region facing one surface of the first electrode, and a region protruding to a side of the other surface of the first electrode.

### Effects of the Invention

As described above, according to the present disclosure, it is possible to suppress the occurrence of communication not intended by the user.

Note that the effects described above are not necessarily limited, and together with or in lieu of the effects described above, any of the effects described in the present description, or other effects that can be grasped from the present description may be exhibited.

### BRIEF DESCRIPTION OF DRAWINGS

FIG. 1 is an explanatory view illustrating a configuration of a human body communication system.

FIG. 2 is an explanatory view illustrating a configuration of a wearable terminal.

FIG. 3 is an explanatory view illustrating an arrangement example of two sets of electrodes.

FIG. 4 is an explanatory diagram illustrating signal intensity at a reception electrode of a signal transmitted from each rotational position.

FIG. 5 is a perspective view of an installed terminal according to a first embodiment.

FIG. 6 is a top view and a cross-sectional view of the installed terminal according to the first embodiment.

FIG. 7 is an explanatory view illustrating an installed terminal according to the first embodiment.

FIG. 8 is an explanatory diagram illustrating a simulation of sensitivity of the installed terminal in each direction according to the first embodiment.

FIG. 9 is an explanatory view illustrating an installed terminal according to a second embodiment.

FIG. 10 is an explanatory diagram illustrating a simulation of sensitivity of the installed terminal in each direction according to the second embodiment.

FIG. 11 is an explanatory view illustrating an installed terminal according to a third embodiment.

FIG. 12 is an explanatory diagram illustrating a simulation of sensitivity of the installed terminal in each direction according to the third embodiment.

FIG. 13 is an explanatory view illustrating an installed terminal according to a fourth embodiment.

FIG. 14 is an explanatory diagram illustrating a simulation of sensitivity of the installed terminal in each direction according to the fourth embodiment.

FIG. 15 is an explanatory view illustrating the configuration of an installed terminal according to a modification.

### MODE FOR CARRYING OUT THE INVENTION

Hereinafter, preferred embodiments of the present disclosure will be described in detail with reference to the accompanying drawings. Note that in the present description and the drawings, constituents having substantially the same functional configuration are denoted by the same reference signs and thus redundant description will be omitted.

Furthermore, in the present description and the drawings, there are cases where a plurality of constituents having substantially the same functional configuration is distinguished by attaching different alphabets after the same reference signs. However, in a case where there is no need to particularly distinguish each of a plurality of constituents having substantially the same functional configuration, only the same reference sign is given to each of the plurality of constituents.

Furthermore, the present disclosure will be described according to the item order indicated below.
0. Overview of human body communication system
1. First Embodiment
2. Second Embodiment
3. Third Embodiment
4. Fourth Embodiment
5. Conclusion

### 0. Overview of Human Body Communication System

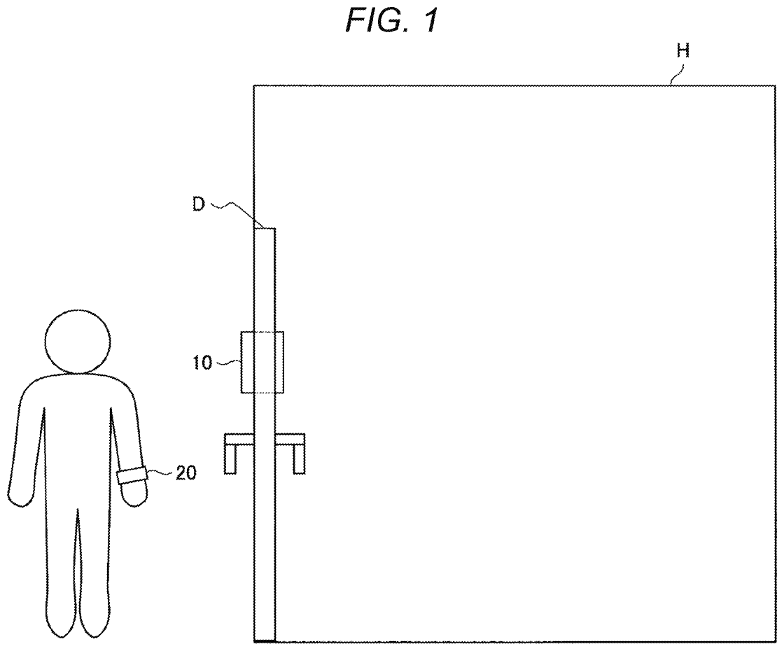

An embodiment of the present disclosure is applied to a human body communication system also called a body area network (BAN). BAN communication (human body communication) between terminals in the human body communication system is realized by causing electrodes provided on a terminal to distribute an electric field on a human body surface. Hereinafter, a specific configuration example of such a human body communication system will be described with reference to FIG. 1.

FIG. 1 is an explanatory view illustrating a configuration of a human body communication system. FIG. 1 illustrates a human body communication system including an installed terminal 10 and a wearable terminal 20.

The installed terminal 10 is an example of an electrode device having at least two electrodes, and is installed on a door D of a building H in the example illustrated in FIG. 1. The installed terminal 10 also includes a communication processing unit such as a reception processing unit that extracts a reception signal from a potential difference generated between the two electrodes, and a transmission processing unit that generates a potential difference between the two electrodes as a signal transmission process. The system of human body communication is not particularly limited, and for example, ISO/IEC 17982 (Close Capacitive Coupling Communication, CCCC) standard may be applied.

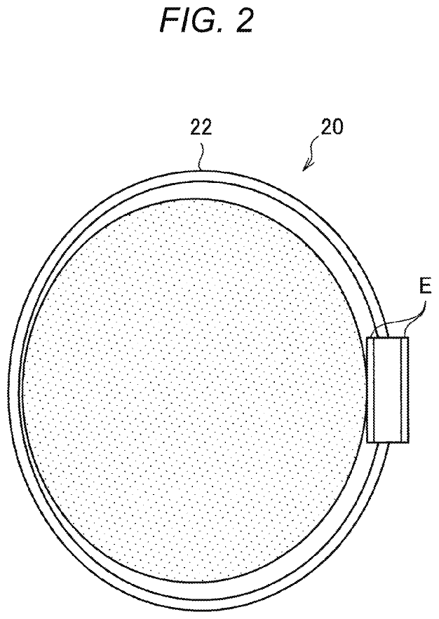

The wearable terminal 20 is a wristband-type communication device. As illustrated in FIG. 2, the wearable terminal 20 includes a band unit 22 worn on a wrist or an arm and two sheets of electrodes E. BAN communication using the electrodes E is realized by causing the electrodes E to generate an electric field on the human body or inducing a reception signal indicating a change in the electric field generated on the human body in the electrodes E.

Note that the two sheets of electrodes E are typically configured of parallel plates. The sizes of the two sheets of electrodes E may be the same or different. Furthermore, the central axes of the two sheets of electrodes E may be the same or different. Furthermore, the shape of the electrode E is not particularly limited. For example, the shape of the electrode E may be rectangular, circular, or a more complicated shape. Furthermore, the wearable terminal 20 is only an example of a communication device, and a portable terminal carried by a user is also applicable as the communication device. Furthermore, the system of human body communication is not particularly limited, and for example, ISO/IEC 17982 (Close Capacitive Coupling Communication, CCCC) standard may be applied.

When the user wearing the above-described wearable terminal 20 touches the electrode of the installed terminal 10, BAN communication between the wearable terminal 20 and the installed terminal 10 is realized via the user's human body. If a predetermined communication sequence succeeds through the BAN communication, the installed terminal 10 drives, for example, an actuator, not illustrated, to control locking or unlocking of the key of the door D.

Here, if the wearable terminal 20 generates an electric field on the human body, a spatial electric field is formed around the wearable terminal 20. For this reason, when the user approaches the installed terminal 10, the wearable terminal 20 and installed terminal 10 can be spatially coupled to each other even though the user does not touch the electrode of the installed terminal 10. As a result, BAN communication is performed between the wearable terminal 20 and the installed terminal 10 and locking or unlocking of the door D is performed.

### BACKGROUND

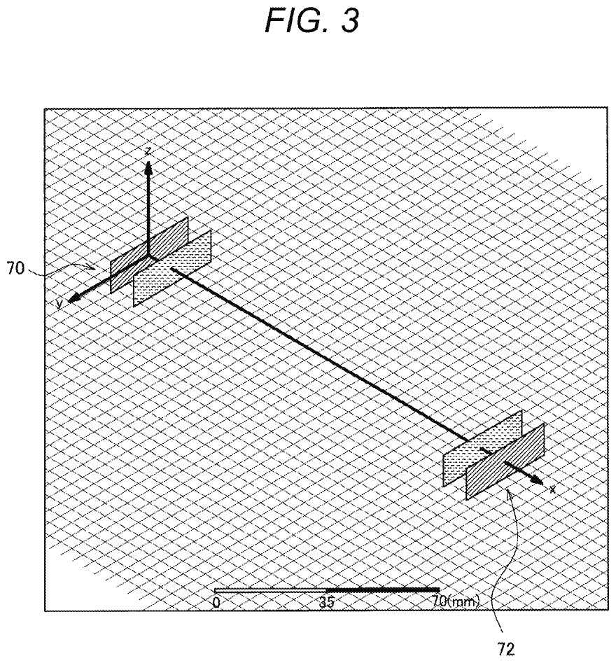

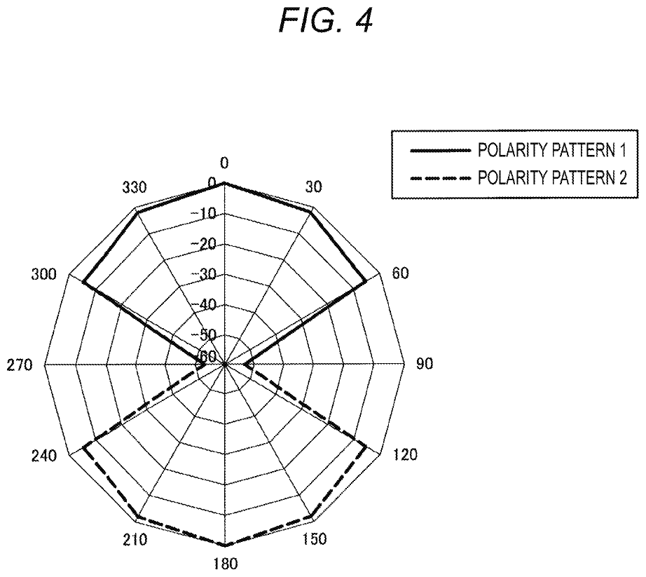

However, in a case where an installed terminal in which two electrodes are configured of two sheets of parallel plates is used, the wearable terminal 20 and the installed terminal are spatially coupled to each other also when the user wearing the wearable terminal 20 approaches the installed terminal from the inside of the building H. As a result, locking or unlocking of the door D not intended by the user is performed. Hereinafter, this point will be described with reference to FIGS. 3 and 4.

FIG. 3 is an explanatory view illustrating an arrangement example of two sets of electrodes. In FIG. 3, a reception electrode 70 and a transmission electrode 72 are illustrated, and the transmission electrode 72 is located in the normal direction of the plane of the reception electrode 70. Assuming that the position of the transmission electrode 72 illustrated in FIG. 3 is 0 deg (front), in a case where the transmission electrode 72 rotates around the z axis illustrated in FIG. 3 within the range of 0 deg to 360 deg, signal intensity of the signal that the reception electrode 70 receives from the transmission electrode 72 changes as illustrated in FIG. 4.

FIG. 4 is an explanatory diagram illustrating signal intensity at the reception electrode 70 of a signal transmitted from each rotational position. The number such as “−10” or “−20” in FIG. 4 indicates the dB value of the sensitivity in each direction based on the sensitivity to 0 deg. As illustrated in FIG. 4, the signal intensity at the reception electrode 70 of the signals transmitted at 0 deg and at 180 deg is maximal. The reception electrode 70 has sufficient sensitivity for signals transmitted from a wide range including 0 deg and 180 deg. Note that in FIG. 4, the solid line indicates a polarity pattern 1, and the broken line indicates the polarity pattern 2. The polarity pattern 1 and the polarity pattern 2 are opposite polarity patterns. A signal transmitted from the front side of the reception electrode 70 has the polarity pattern 1, and a signal transmitted from the back side of the reception electrode 70 has the polarity pattern 2.

In the installed terminal having the reception electrode 70 described above, the reception electrode 70 has equal sensitivity to a signal transmitted from the outside of the building H (for example, 0 deg) and a signal transmitted from the inside of the building H (for example, 180 deg). For this reason, even if the user wearing the wearable terminal 20 approaches the installed terminal from either the outside or the inside of the building H, the installed terminal and the wearable terminal 20 can be spatially coupled to each other.

In this regard, it is conceivable that on the basis of the polarity pattern of a signal received by the reception electrode 70, whether or not the signal is a signal transmitted from the outside or the inside of the building H is determined. However, since the reception electrode 70 has reception sensitivity in a wide angle range, it is difficult to determine the position of the signal transmission source with high accuracy only from the polarity pattern.

Accordingly, the inventor of the present invention has created embodiments of the present disclosure by focusing on the circumstances described above. According to the embodiments of the present disclosure, it is possible to determine the positional relationship between the installed terminal 10 and the wearable terminal 20 with high accuracy, and as a result, it is possible to suppress the occurrence of communication not intended by the user. Hereinafter, an installed terminal 11 according to a first embodiment, an installed terminal 12 according to a second embodiment, an installed terminal 13 according to a third embodiment, and an installed terminal 14 according to a fourth embodiment will be sequentially described in detail. Note that in the present description, the expression, installed terminal 10 is used as a concept encompassing the installed terminals 11 to 14 according to the respective embodiments.

### 1. First Embodiment

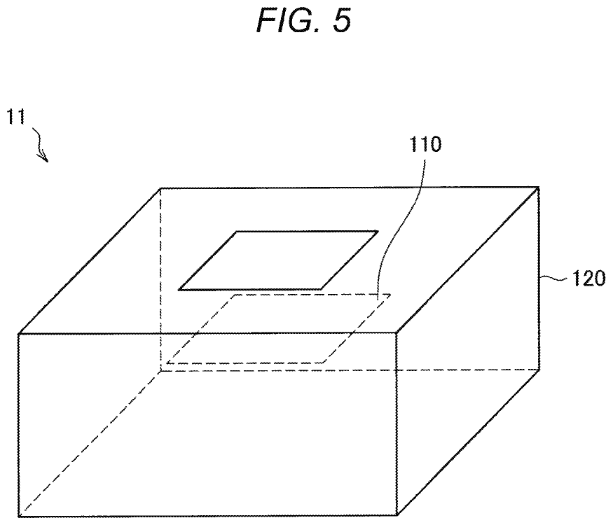

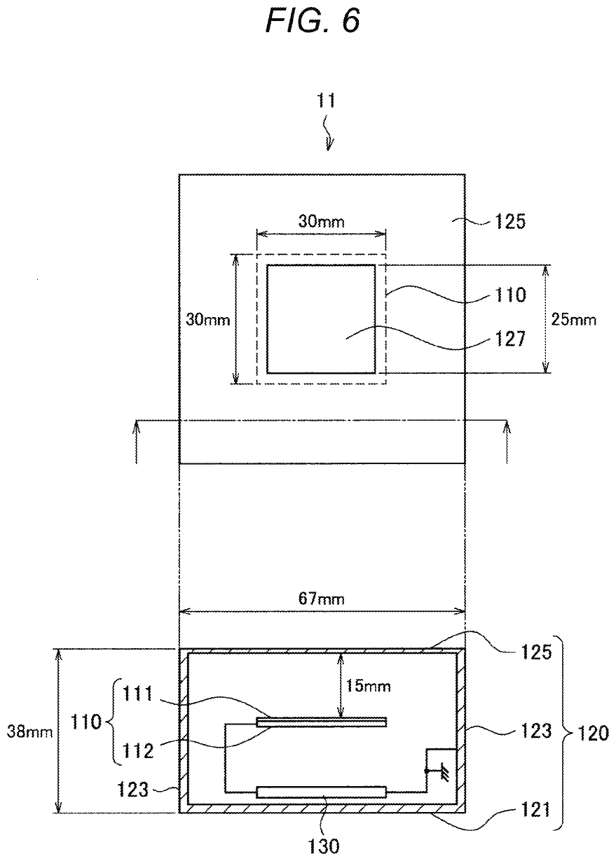

FIG. 5 is a perspective view of an installed terminal 11 according to the first embodiment. FIG. 6 is a top view and a cross-sectional view of the installed terminal 11 according to the first embodiment.

As illustrated in FIGS. 5 and 6, the installed terminal 11 according to the present embodiment includes a plate electrode 110 (first electrode), a rectangular parallelepiped-shaped electrode 120 (second electrode), and a control board 130.

As illustrated in FIGS. 5 and 6, the plate electrode 110 is a conductor disposed inside the rectangular parallelepiped-shaped electrode 120. The plate electrode 110 has an upper surface 111 and a lower surface 112. As illustrated in the top view of FIG. 6, the upper surface 111 and the lower surface 112 may be, for example, a square having a side length of 30 mm.

The rectangular parallelepiped-shaped electrode 120 is a rectangular parallelepiped-shaped conductor having a bottom surface 121, side surfaces 123 perpendicular to the bottom surface 121, and an upper surface 125 facing the bottom surface 121. The bottom surface 121 is a region facing the lower surface 112 of the plate electrode 110. The side surfaces 123 and the upper surface 125 are regions that protrude from the bottom surface 121 to the side of the upper surface 111 of the plate electrode 110. Furthermore, the upper surface 125 of the rectangular parallelepiped-shaped electrode 120 is a surface facing the upper surface 111 of the plate electrode 110 and has an opening 127 in the center.

As illustrated in FIG. 6, for example, the bottom surface 121 may be a square having a side length of 67 mm and the height of the side surface 123 may be 38 mm. The opening 127 may be a square having a side length of 25 mm, and the difference in height between the plate electrode 110 and the upper surface 125 of the rectangular parallelepiped-shaped electrode 120 may be 15 mm. The plate electrode 110 and the side surfaces 123 of the rectangular parallelepiped-shaped electrode 120 are spaced apart from each other, that is, the area of the plate electrode 110 is smaller than the area of the bottom surface 121 of the rectangular parallelepiped-shaped electrode 120. Furthermore, the lower surface 112 of the plate electrode 110 and the bottom surface 121 of the rectangular parallelepiped-shaped electrode 120 are spaced apart. Note that the rectangular parallelepiped-shaped electrode 120 and the plate electrode 110 can be formed of, for example, copper.

The control board 130 is configured to perform a signal process for BAN communication, and is electrically connected to the plate electrode 110 and the rectangular parallelepiped-shaped electrode 120. The control board 130 includes, for example, a central processing unit (CPU), a modem unit (PHY, MAC), a transmission processing unit, a reception processing unit, and the like. The modem unit modulates transmission data supplied from the CPU to generate a modulating signal, and the transmission processing unit applies the modulating signal to the plate electrode 110 and the rectangular parallelepiped-shaped electrode 120 in a predetermined frequency band, and thus signal transmission is realized. Furthermore, the signals input from the plate electrode 110 and the rectangular parallelepiped-shaped electrode 120 are subjected to a reception process such as amplification and band limiting for extracting a necessary frequency band, the modem unit demodulates reception data from the signals subjected to the reception process, and thus signal reception is realized.

Furthermore, the control board 130 according to the present embodiment includes the function as a control unit that determines whether or not signal intensity of a signal received from another electrode device such as the wearable terminal 20 exceeds a threshold, and outputs a control signal according to the determination result. For example, the control board 130 outputs a control signal for unlocking or locking the door D according to the judgment result described above.

The installed terminal 11 as described above is installed on the door D so that the opening 127 is directed to the outside of the building H. The installed terminal 11 installed on the door D has stronger sensitivity to a signal transmitted from the outside of the building H than to a signal transmitted from the inside of the building H. This is based on the fact that the rectangular parallelepiped-shaped electrode 120 has a region protruding to the upper surface 111 side of the plate electrode 110.

Specifically, in the spatial electric field formed by the wearable terminal 20 positioned on the lower surface 112 side of the plate electrode 110, that is, the inside of the building H, since the region described above of the rectangular parallelepiped-shaped electrode 120, the bottom surface 121 and the like are interposed between the wearable terminal 20 and the plate electrode 110, a potential difference is hardly generated between the plate electrode 110 and the rectangular parallelepiped-shaped electrode 120.

In contrast, in the spatial electric field formed by the wearable terminal 20 positioned on the upper surface 111 side of the plate electrode 110, that is, the outside of the building H, since the plate electrode 110 and the wearable terminal 20 are not shielded by the rectangular parallelepiped-shaped electrode 120 due to existence of the opening 127, a potential difference is likely to generate between the plate electrode 110 and the rectangular parallelepiped-shaped electrode 120.

As a result, as described above, the installed terminal 11 installed on the door D has stronger sensitivity to a signal transmitted from the outside of the building H than to a signal transmitted from the inside of the building H. Hereinafter, the sensitivity of the installed terminal 11 in each direction will be specifically described.

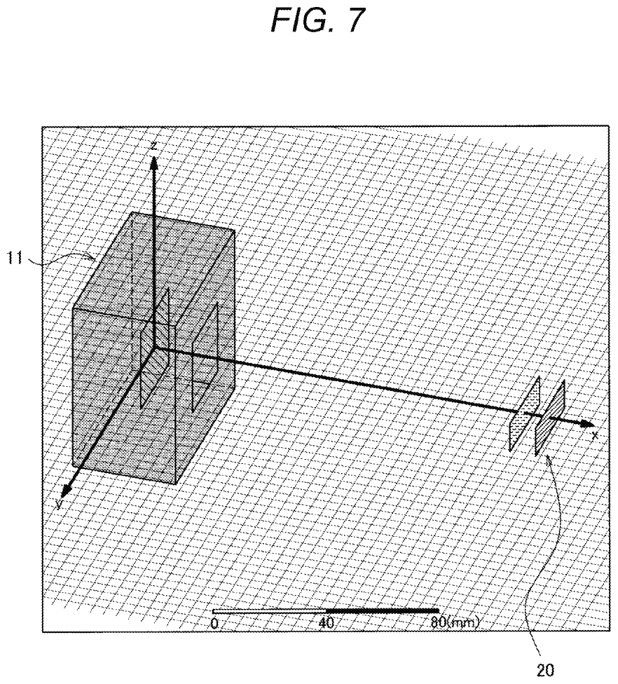

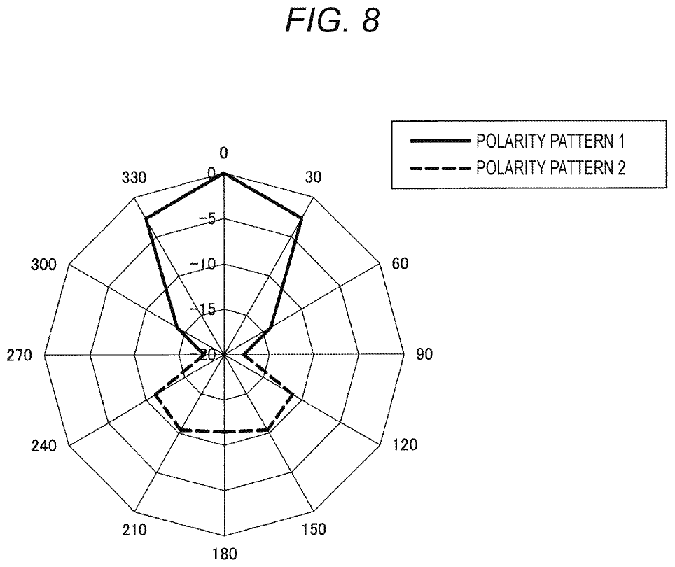

FIG. 7 is a perspective view of the installed terminal 11, and FIG. 8 is an explanatory diagram illustrating a simulation of sensitivity of the installed terminal 11 in each direction. Assuming that the normal direction (x direction, front direction) of the plate electrode 110 directed from the plate electrode 110 to the opening 127 illustrated in FIG. 7 is 0 deg, in a case where the wearable terminal 20 rotates around the z axis within the range of 0 deg to 360 deg, signal intensity of the signal that the installed terminal 11 receives from the wearable terminal 20 changes as illustrated in FIG. 8. The number such as “−5” or “−10” in FIG. 8 indicates the dB value of the sensitivity in each direction based on the sensitivity to 0 deg.

As illustrated in FIG. 8, the sensitivity of the installed terminal 11 is significantly higher in 0 to 90 deg and 270 to 0 deg than in 90 deg to 270 deg. That is, the installed terminal 11 has higher sensitivity to a signal from the outside of the building H than to a signal from the inside of the building H. Furthermore, comparing FIG. 4 with FIG. 8, in the example of FIG. 4, sensitivity exists in the range of about 120 deg on the front side; however the range in which the installed terminal 11 according to the present embodiment has sensitivity is limited to the range of about 60 deg on the front side as illustrated in FIG. 8.

Here, the control board 130 of the installed terminal 11 determines whether or not signal intensity of the signal received from the wearable terminal 20 exceeds a threshold, controls communication (for example, association sequence) for establishing a connection with the wearable terminal 20 in a case where the signal intensity of the signal received from the wearable terminal 20 exceeds the threshold, and outputs a control signal for unlocking or locking the door D in a case where authentication succeeds. In a case where the signal intensity of the signal received from the wearable terminal 20 is equal to or lower than the threshold, the control board 130 may discard the signal.

Therefore, the installed terminal 11 according to the present embodiment communicates with the wearable terminal 20 of the user who has approached the door D from the outside of the building H through spatial coupling; however, hardly communicates with the wearable terminal 20 of the user who has approached the door D from the inside of the building H. For this reason, it is possible to suppress the occurrence of a case where when the user wearing the wearable terminal 20 approaches the door D from the inside of the building H, unlocking or locking of the door D not intended by the user is performed.

Moreover, the control board 130 may control communication with the wearable terminal 20 on the basis of the fact that the signal intensity of the signal received from the wearable terminal 20 exceeds the threshold, and the signal received from the wearable terminal 20 has a predetermined polarity pattern (polarity pattern 1). According to such a configuration, it is possible to more reliably prevent establishment of connection between the wearable terminal 20 positioned inside the building H and the installed terminal 11.

### 2. Second Embodiment

Subsequently, an installed terminal 12 according to a second embodiment of the present disclosure will be described.

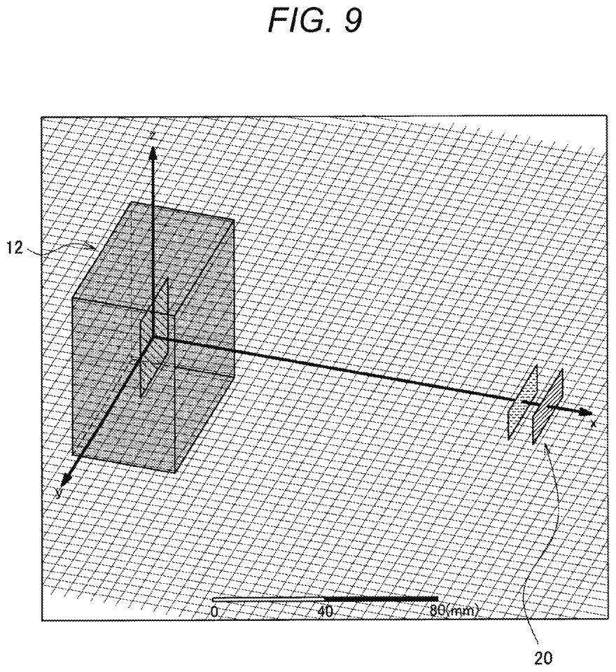

FIG. 9 is an explanatory view illustrating the installed terminal 12 according to the second embodiment. As illustrated in FIG. 9, the installed terminal 12 according to the second embodiment does not have a surface facing an upper surface 111 of a plate electrode 110. That is, the installed terminal 12 has an opening wider than the opening 127 described in the first embodiment.

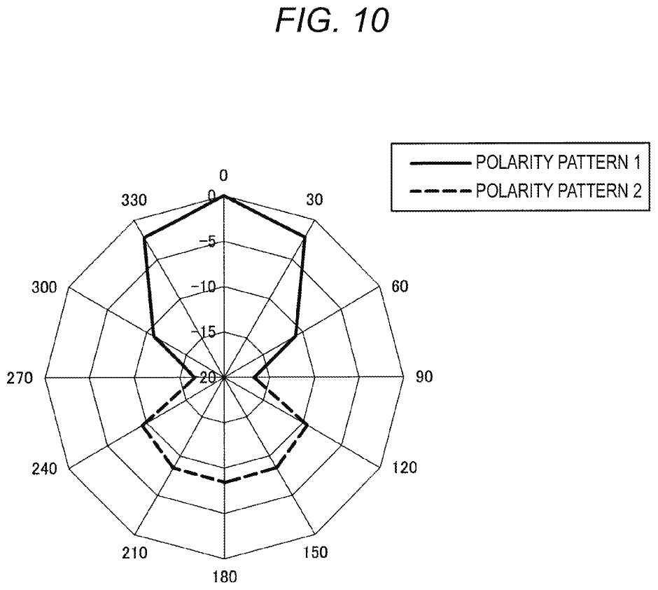

Assuming that the normal direction (x direction, front direction) of the plate electrode 110 directed from the plate electrode 110 to the opening is 0 deg, in a case where the wearable terminal 20 rotates around the z axis within the range of 0 deg to 360 deg, signal intensity of the signal that the installed terminal 11 receives from the wearable terminal 20 changes as illustrated in FIG. 10.

As illustrated in FIG. 10, sensitivity of the installed terminal 12 is higher in 0 to 90 deg and in 270 to 0 deg than in 90 deg to 270 deg, similarly to the simulation result of the first embodiment described with reference to FIG. 8. Moreover, sensitivity at 60 deg and at 300 deg is higher than sensitivity illustrated in the simulation result of the first embodiment. That is, the range in which the installed terminal 12 according to the second embodiment has sensitivity is wider than the range in which the installed terminal 11 according to the first embodiment has sensitivity.

It is possible for such an installed terminal 12 to function more effectively than the installed terminal 11 according to the first embodiment, depending on the characteristics of the door D and the building H on which the installed terminal 12 is installed, or the environment such as required security.

### 3. Third Embodiment

Subsequently, an installed terminal 13 according to a third embodiment of the present disclosure will be described.

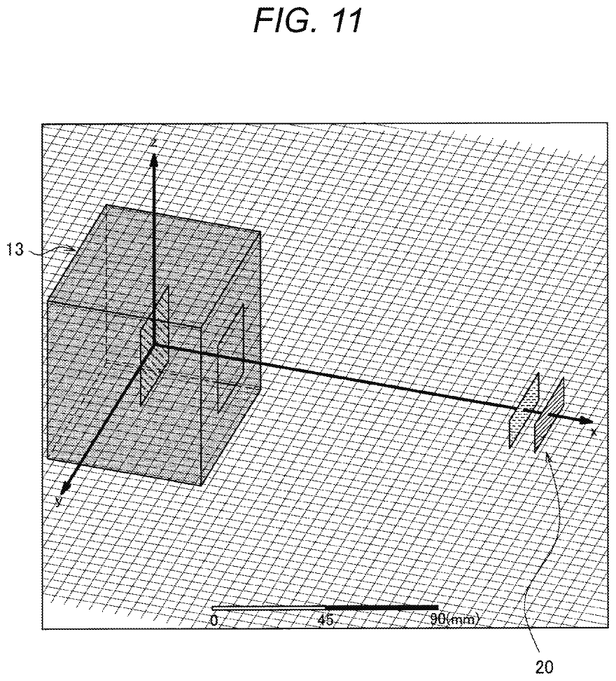

FIG. 11 is an explanatory view illustrating an installed terminal 13 according to the third embodiment. The installed terminal 13 according to the third embodiment differs from the installed terminal 11 according to the first embodiment with respect to the height (length between a bottom surface 121 and an upper surface 125). The height of the installed terminal 13 according to the third embodiment is greater than the height of the installed terminal 11 according to the first embodiment. For example, the height of the installed terminal 13 according to the third embodiment is 60 mm.

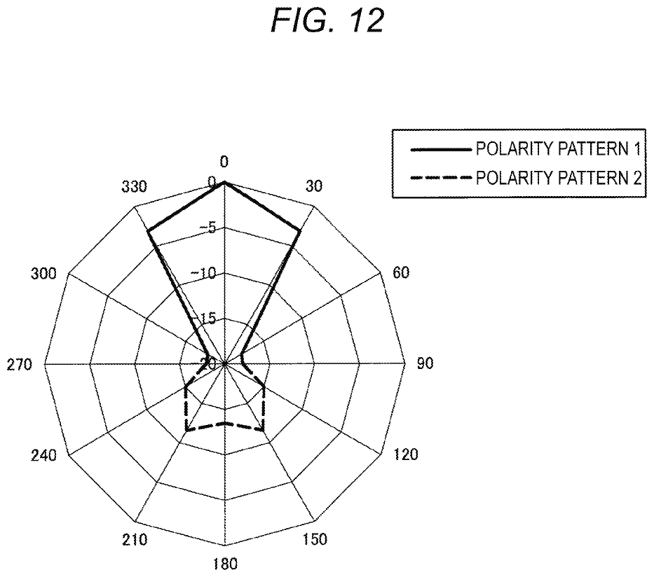

Assuming that the normal direction (x direction, front direction) of a plate electrode 110 directed from the plate electrode 110 to an opening 127 is 0 deg, in a case where a wearable terminal 20 rotates around the z axis within the range of 0 deg to 360 deg, signal intensity of the signal that the installed terminal 13 receives from the wearable terminal 20 changes as illustrated in FIG. 12.

That is, as illustrated in FIG. 12, the range in which the installed terminal 13 according to the third embodiment has sensitivity is narrower than the range in which the installed terminal 11 according to the first embodiment has sensitivity. That is, the installed terminal 13 according to the third embodiment can further limit the range in which the wearable terminal 20 can establish a connection with the installed terminal 13.

Note that from the simulation result of the first embodiment and the simulation result of the third embodiment, it can be seen that as the height of the installed terminal 10 increases, and furthermore, the difference in height between the plate electrode 110 and the upper surface 125 of the installed terminal 10 increases, the range in which the installed terminal 10 has sensitivity can be made narrower. Considering that with the configuration of the installed terminal 11 according to the first embodiment, the range of sensitivity is narrower than in the example illustrated in FIG. 4, the height of the installed terminal 10 is preferably equal to or greater than 38 mm, which is the height of the installed terminal 11 according to the first embodiment, and the difference in height between the plate electrode 110 and the upper surface 125 of the installed terminal 10 is preferably equal to or greater than 15 mm, which is the difference in height in the first embodiment. More preferably, the height of the installed terminal 10 may be equal to or greater than 60 mm, which is the height of the installed terminal 13 according to the first embodiment.

### 4. Fourth Embodiment

Subsequently, an installed terminal 14 according to a fourth embodiment of the present disclosure will be described.

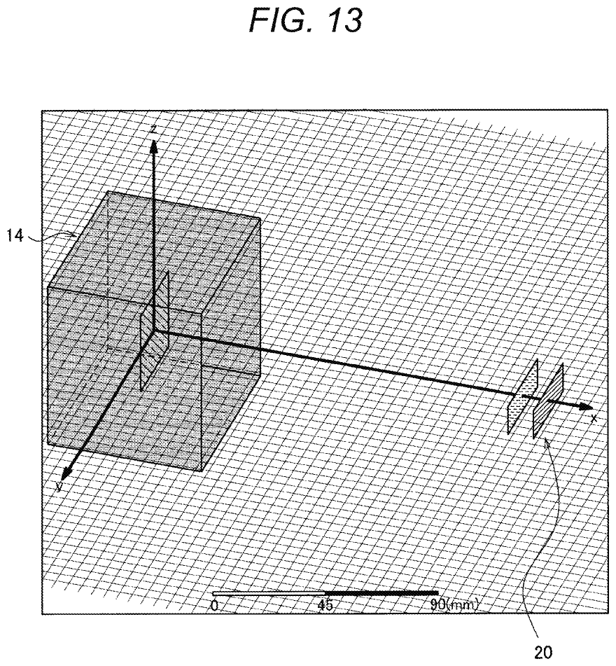

FIG. 13 is an explanatory view illustrating the installed terminal 14 according to the fourth embodiment. The installed terminal 14 according to the fourth embodiment differs from the installed terminal 12 according to the second embodiment with respect to the height (length of a side surface 123 from a bottom surface 121). The height of the installed terminal 14 according to the fourth embodiment is greater than the height of the installed terminal 12 according to the first embodiment.

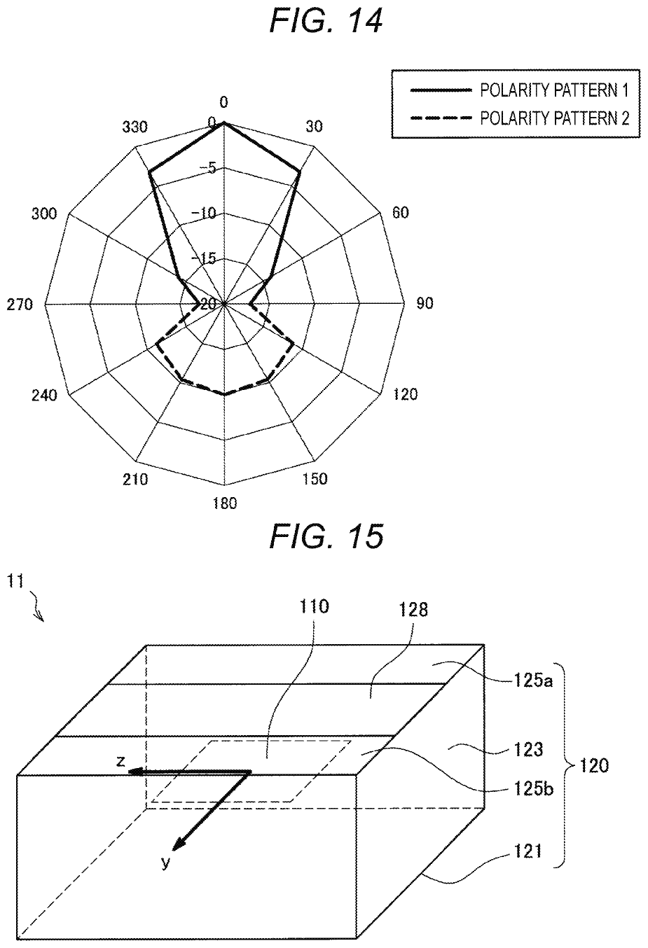

Assuming that the normal direction (x direction, front direction) of a plate electrode 110 directed from the plate electrode 110 to an opening is 0 deg, in a case where a wearable terminal 20 rotates around the z axis within the range of 0 deg to 360 deg, signal intensity of the signal that the installed terminal 14 receives from the wearable terminal 20 changes as illustrated in FIG. 14.

As illustrated in FIG. 14, the range in which the installed terminal 14 has sensitivity is narrower than the range in which the installed terminal 12 according to the second embodiment has sensitivity. That is, the installed terminal 14 according to the fourth embodiment can further limit the range in which the wearable terminal 20 can establish a connection with the installed terminal 14 than that in the second embodiment.

### 5. CONCLUSION

As described above, according to the embodiments of the present disclosure, it is possible to suppress the occurrence of a case where when the user wearing the wearable terminal 20 approaches the door D from the inside of the building H, unlocking or locking of the door D not intended by the user is performed.

Note that while preferred embodiments of the present disclosure have been described in detail with reference to the accompanying drawings, the technical scope of the present disclosure is not limited to such examples. It is obvious that a person skilled in the art of the present disclosure can conceive various modifications and corrections within the scope of the technical idea described in the claims, and it is naturally understood that these modifications and corrections also belong to the technical scope of the present disclosure.

For example, even though the examples in which the installed terminal 10 is installed on the door D of the building H have been described above, an installed terminal 10 may be installed on a door D of a room inside a building H. Furthermore, an installed terminal 10 may be installed on a door of a vehicle such as an automobile or a ship.

Furthermore, in the first embodiment, the example in which the square opening 127 is formed in the upper surface 125 of the installed terminal 11 has been described with reference to FIG. 6 and the like; however, the configuration of the opening 127 is not limited to the example illustrated in FIG. 6. For example, as illustrated in FIG. 15, in an installed terminal 11, an upper surface 125a and an upper surface 125b may be separately provided, and as a result, a rectangular opening 128 may be formed. In such a configuration, it is possible to secure relatively wide sensitivity on the circumference having the axis in the lateral direction of the opening 128 as the rotation axis (y axis), and to limit the range of sensitivity on the circumference having the axis in the longitudinal direction of the opening 128 as the rotation axis (z axis).

Furthermore, even though the examples in which the installed terminal 10 has a rectangular parallelepiped shape have been described above, the shape of the installed terminal 10 is not limited to a rectangular parallelepiped shape. For example, an installed terminal 10 may have a cylindrical shape or a spherical shape.

Furthermore, the effects described in the present description are illustrative or exemplary only and are not limited. That is, the technique according to the present disclosure can exhibit other effects that are apparent to those skilled in the art from the description of the present description in addition to or in lieu of the effects described above.

Furthermore, the following configurations also belong to the technical scope of the present disclosure.

(1)

An electrode device including:
a first electrode; and
a second electrode,
in which the second electrode has a region facing one surface of the first electrode, and a region protruding to the side of the other surface of the first electrode.

(2)

The electrode device according to (1), in which the region protruding to the side of the other surface includes a region facing the other surface of the first electrode.

(3)

The electrode device according to (2), in which the region facing the other surface has an opening.

(4)

The electrode device according to any one of (1) to (3), in which the second electrode has a rectangular parallelepiped shape, has a bottom surface as the region facing the one surface of the first electrode, and has a side surface including the region protruding to the side of the other surface of the first electrode.

(5)

The electrode device according to (4),
in which the height of the second electrode from the bottom surface is not shorter than 38 mm, and
a difference in height between the first electrode and an end of the side surface on the side of the other surface of the first electrode is not shorter than 15 mm.

(6)

The electrode device according to any one of (1) to (5) further including a control unit configured to control connection establishment on the basis of the fact that signal intensity of a signal received from another electrode device exceeds a threshold.

(7)

The electrode device according to (6), in which the control unit controls the connection establishment on the basis of the fact that the signal intensity of the signal received from the other electrode device exceeds the threshold and the signal received from the other electrode device has a predetermined polarity pattern.

### REFERENCE SIGNS LIST

10 to 14 Installed terminal
20 Wearable terminal
22 Band unit
110 Plate electrode
111 Upper surface
112 Lower surface
120 Rectangular parallelepiped-shaped electrode
121 Bottom surface
123 Side surface
125 Upper surface
127, 128 Opening
130 Control board

1. An electrode device comprising:
a first electrode; and
a second electrode,
wherein the second electrode has a region facing one surface of the first electrode, and a region protruding to a side of another surface of the first electrode.

2. The electrode device according to claim 1, wherein the region protruding to the side of the another surface includes a region facing the another surface of the first electrode.

3. The electrode device according to claim 2, wherein the region facing the another surface has an opening.

4. The electrode device according to claim 1, wherein the second electrode has a rectangular parallelepiped shape, has a bottom surface as the region facing the one surface of the first electrode, and has a side surface including the region protruding to the side of the another surface of the first electrode.

5. The electrode device according to claim 4,
wherein a height of the second electrode from the bottom surface is not shorter than 38 mm, and
a difference in height between the first electrode and an end of the side surface on the side of the another surface of the first electrode is not shorter than 15 mm.

6. The electrode device according to claim 1 further comprising a control unit configured to control connection establishment on a basis of a fact that signal intensity of a signal received from another electrode device exceeds a threshold.

7. The electrode device according to claim 6, wherein the control unit controls the connection establishment on a basis of a fact that the signal intensity of the signal received from the another electrode device exceeds the threshold and the signal received from the another electrode device has a predetermined polarity pattern.
